(19) United States
(12) Patent Application Publication
(10) Pub. No.: US 2009/0316949 A1
(43) Pub. Date: Dec. 24, 2009

(54) Electrodynamic loudspeaker device

(75) Inventor: Annick S. I. Ermens, Eindhoven (NL)

Correspondence Address: SHEEHAN PHINNEY BASS & GREEN, PA;c/o PETER NIEVES, 1000 ELM STREET, MANCHESTER, NH, 03105-3701, US

(73) Assignee: PSS Belgium N.V., Dendermonde (BE)

(21) Appl. No.: 12/066,577

(22) PCT Filed: Sep. 4, 2006
(86) PCT No.: PCT/IB06/53093

§ 371 Date: Dec. 8, 2008

(30) Foreign Application Priority Data
Sep. 15, 2005 (EP) 05108482.0

(51) Int. Cl. H04R 9/06

(52) U.S. Cl. 381/432; 381/433

(57) ABSTRACT

An electrodynamic loudspeaker device comprising a chassis (1), a translatable body (3) and an actuator (11) arranged for moving the translatable body (3) with regard to the chassis (1). The translatable body (3) is provided with (1) a three-dimensional diaphragm body (5) having a contour (5_{c}), a diaphragm base part (5_{b}) and a diaphragm top part (5ₜ) which is wider than said base part (5_{b}), an axial axis (5ₐ) extending from the one part to the other part and (2) a support body (7). The support body (7) has a bound support end portion (7_{b}) fixed to the diaphragm base part (5_{b}) and a free support end portion (7_{f}) and extends substantially parallel to the axial axis (5ₐ) and at least partly inside a space (9) enveloped by the contour (5_{c}) of the diaphragm body (5). The actuator (11) comprises a stationary actuator part (11ₛ) supported by the chassis (1) and a movable actuator part (11ₘ) supported by the support body (7) and sited between both support end portions. These actuator parts are arranged for magnetically cooperating with each other across an air gap (13). The diaphragm top part (5ₜ) is secured to the chassis (1) by means of a flexible suspension means (15) and the free support end portion (7_{f}) is suspended from the chassis (1) by means of a flexible centering means (17) in order to provide a flat and during operation stable and resonance free device.

The invention relates to an electrodynamic loudspeaker device which comprises a chassis and a translatable body provided with a three-dimensional diaphragm body having a diaphragm base part, a diaphragm top part which is wider than the diaphragm base part and an axial axis extending from the one part to the other part of said parts and further provided with a support body, which support body has a bound support end portion fixed to the diaphragm base part and a free support end portion and extends substantially parallel to the axial axis and at least partly inside a space enveloped by the contour of the diaphragm body, the loudspeaker device further comprising an actuator, particularly an electromagnetic actuator, arranged for moving the translatable body with regard to the chassis, wherein the actuator comprises a stationary actuator part supported by the chassis and a movable actuator part supported by the support body and sited between both support end portions, the actuator parts being arranged for magnetically co-operating with each other across an air gap, and wherein the diaphragm top part is secured to the chassis by means of a flexible suspension means.

The International Application WO 88/08239 discloses a loudspeaker of the above-mentioned kind, being a so-called inverted co-axial speaker. This known loudspeaker comprises a basket-like frame which includes a back wall and a perimetral wall, and a magnet assembly. The magnet assembly includes a center pole piece and a yoke. The center pole piece and the yoke are mounted to the back wall to define an air gap. The magnet assembly includes a permanent magnet to provide a magnetic field in the air gap. The loudspeaker further includes a voice coil, a voice coil form for supporting the voice coil in the air gap, a spider means for positioning the voice coil form in the air gap, and a diaphragm having an apex and a perimeter. The diaphragm is coupled to the frame at the perimetrally outer extent of the diaphragm and is coupled to the voice coil form inward from the perimeter of the diaphragm. The spider is attached to the voice coil form near the coupling between coil form and diaphragm and is further attached to the frame, and is mounted between the diaphragm and the magnet assembly and is generally concave on the side of the spider facing the magnet assembly to enclose and house the magnet assembly. The spider is generally convex on the side of the spider facing away from the magnet assembly and toward the diaphragm. The apex of the diaphragm extends away from the back wall farther than the perimeter of the diaphragm to enclose and house the spider.

Although the known inverted speaker has a smaller axial dimension than the generally known conventional loudspeakers in which the actuator is situated behind a back plane of a speaker cone, a disadvantage of the known speaker is that the suspension of the coil form is such that during use stable axial displacements of the voice coil with respect to the magnet assembly are not guaranteed and resonances of the speaker, and thus sound distortions, may be caused.

It is an object of the invention to provide a flat and during operation stable and resonance free loudspeaker device.

This object is achieved by the loudspeaker device as defined in claim 1. With regard to the loudspeaker device as described in the preamble, the loudspeaker device according to the invention has the additional feature that the free support end portion of the support body is suspended from the chassis by means of a flexible centering means. Due to the applied suspension arrangement the movable actuator part, and thus the support body, is carefully centered and guided with respect to the chassis, and thus to the stationary actuator part, while moving, whereby vibration of the support body in lateral direction, and therefor resonances of the loudspeaker, are prevented. Preferably, a dust cap is provided on top of the diaphragm top part. The invertedly oriented diaphragm in combination with the arrangement of the centering means enables a very flat and high stability loudspeaker device. In this context a preferred embodiment of the loudspeaker device according to the invention has the feature that the flexible centering means comprises a substantially flat spider web-like supporting structure which has an inner edge attached to the free support end portion and an outer edge attached in the chassis. In a practical embodiment the diaphragm body is a conical body known per se and/or the support body is a tube-like body known per se.

An embodiment of the loudspeaker device according to the invention, wherein the stationary actuator part comprises a magnet unit and the movable actuator part comprises an electric coil unit, has preferably the feature that the magnet unit comprises an outside magnet unit part extending outside of the support body and extending in a space bounded by the diaphragm body and the flexible centering means. In this embodiment an optimal use is made of the space enveloped by the contour of the diaphragm body. In order to guarantee generation of sufficient magnetic driving forces in all circumstances, the above-mentioned embodiment has preferably the additional feature that the magnet unit comprises an inside magnet unit part extending at least partly inside the support body. In this way the outside and inside magnet unit parts define a gap, wherein the coil unit extends in this gap. In a practical embodiment the outside magnet unit part is a ring-shaped body which surrounds the support body and is fixed to an axially extending frame being a part of the chassis. Such a frame may be embodied by a frame having a conical structure or by a frame formed by a structure of pin-like elements extending substantially axially and through apertures in the flexible centering means.

In another practical embodiment the inside magnet unit part is fixed to a central mounting structure being a part of the chassis and/or the inside magnet unit part comprises at least one permanent magnet.

A further practical embodiment of the loudspeaker device according to the invention has the feature that the flexible suspension means comprises a ring-shaped roll structure, which may be of a known kind, having an inner rim attached to the diaphragm top part and an outer rim attached to the chassis.

Several embodiments of the loudspeaker device according to the invention are defined in the claims 2 to 14.

The loudspeaker device according to the invention is particularly suitable for automotive applications, for which applications an ever increasing demand for flat speakers exists. The loudspeaker device according to the invention satisfies this demand and is particularly usable as midrange speaker, however is not limited to such a use. Evidently, the loudspeaker device can favourably be applied in other domains, such as audio/video.

It is to be noted that patent U.S. Pat. No. 6,526,151 B1 discloses a loudspeaker which comprises a voice coil curled from a thin piece, at which a top end and a bottom end each are attached to a roll suspension in order to provide supporting fulcrums at two ends. The loudspeaker further comprises a magnetic yoke and a slightly concave diaphragm having a diameter which corresponds to the diameter of the voice coil. The diaphragm is solely secured to the top end of the voice coil and does not have an own suspension means. This known loudspeaker, which does not belong to the type of inverted speakers, has either a relatively small sound radiating surface or requires a relatively large voice coil.

It is noted in relation to the claims that various combinations of characteristic features defined in the claims are possible and aimed at.

The above-mentioned and other aspects of the invention are apparent from and are elucidated, by way of non-limitative examples, with reference to the embodiment described hereinafter.

In the drawings:

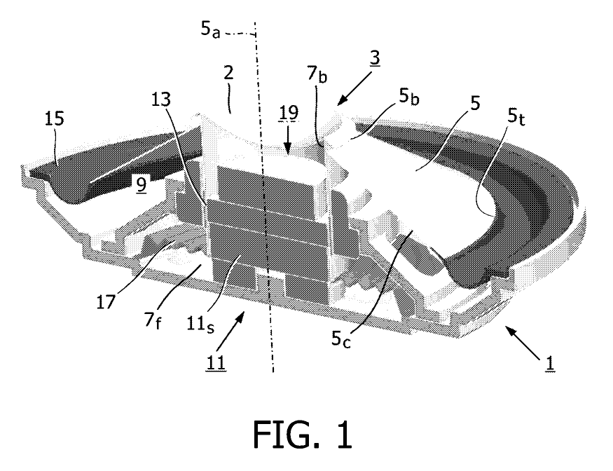

FIG. 1 diagrammatically shows, partly in a perspective view and partly in a longitudinal section, an embodiment of the loudspeaker device according to the invention, and

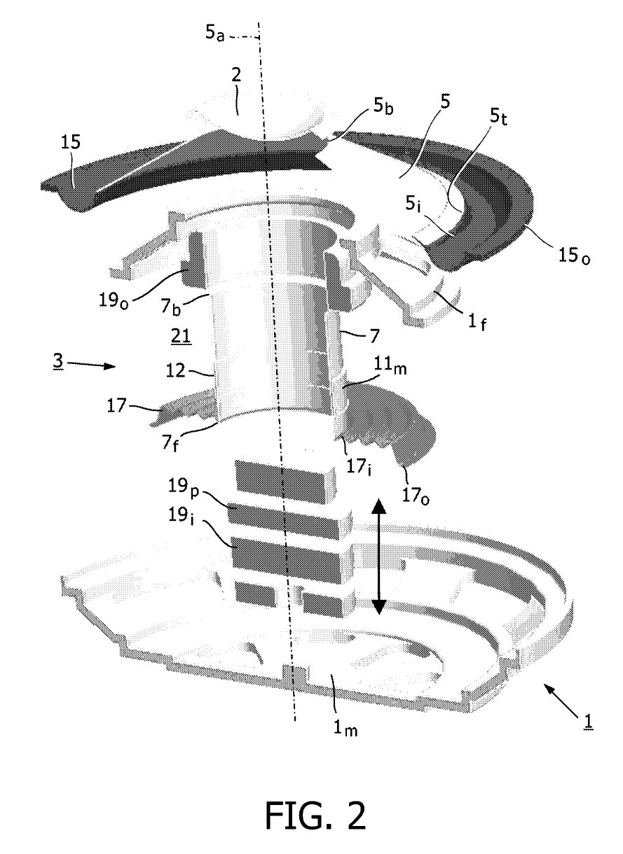

FIG. 2 diagrammatically shows in a perspective exploded view the segment of the loudspeaker device depicted in FIG. 1.

The embodiment of the electrodynamic loudspeaker device according to the invention as depicted in the FIGS. 1 and 2 has a chassis 1, a translatable body 3 and an electromagnetic actuator 11. The chassis 1 may be made of any suitable material, such as a metal, e.g. aluminium, or a stout plastic, for forming a rigid construction. The translatable body 3 comprises a cone-shaped diaphragm body 5 having a contour 5_{c}, a diaphragm base part 5_{b} and a diaphragm top part 5ₜ. The top part 5ₜ is wider than the base part 5_{b}. Preferably, a dust cap 2 is provided on top of the diaphragm top base 5_{f}. An axial axis 5ₐ of the translatable body 3 extends between the diaphragm top part 5ₜ and the diaphragm base part 5_{b}. The translatable body 3 further comprises a tube-like support body 7 for supporting a movable actuator part 11ₘ. The support body 7 extends parallel to the axial axis 5ₐ and has a bound support end portion 7_{b} and a free support end portion 7_{f}. The bound support end portion 7_{b} is attached to the diaphragm base part 5_{b} of the diaphragm body 5 and is situated at least partly in a space 9 enveloped by the contour 5_{c} of the diaphragm body 5. The actuator 11 is meant for moving the translatable body 3 along the axial axis 5ₐ and has a stationary actuator part 11ₛ and the movable actuator part 11ₘ. The stationary part 11ₛ is supported by the chassis 1 and comprises a magnet unit 19 having an inside magnet unit part 19ᵢ and an outside magnet unit part 19ₒ. The inside magnet unit part 19ᵢ, which extends partly inside the support body 7, has at least one permanent magnet 19ₚ, in this example a disc-shaped neodynium magnet, and one or more disc-shaped ferromagnetic elements. The outside magnet unit part 19ₒ is formed in this example by a ring-shaped body of a ferro-magnetic material. This body extends outside the support body 7 and is present in a space 21 bounded by the diaphragm body 5 and a flexible centering means 17. The movable actuator part 11ₘ comprises a coil unit 12, in this example in the form of an electrical coil, which is located between both support end portions 7_{b} and 7_{f}. During operation, the actuator parts 11ₛ, and 11ₘ magnetically cooperate across an air gap 13. The diaphragm top part 5ₜ is secured to the chassis 1 by means of a flexible suspension means 15, formed in this example by a ring-shaped roll body with an Ω-like cross section.

This roll body has an inner rim 15ᵢ attached to the diaphragm top part 5ₜ and an outer rim 15ₒ attached to the chassis 1. The free support end portion 7_{f} is suspended from the chassis 1 by means of the above-mentioned flexible centering means 17, being in this example a slightly corrogated spider. This spider has an inner edge 17ᵢ attached to the free support end portion 7_{f} and an outer edge 17ₒ attached to the chassis 1. The chassis 1 has an axially extending frame 1_{f} to which the outside magnet unit part 19ₒ is fixed. The frame 1_{f} has in this example the form of a truncate cone. Alternatively, the frame 1_{f} may be formed by a structure of pin-like elements which extend substantially axially through apertures in the flexible centering means 17. The chassis 1 further has a central mounting structure 1ₘ to which the inside magnet unit part 19ᵢ is fixed.

During operation, the magnetic field in the airgap 13, combined with an electrical current in the electrical coil 12 causes the translatable body 3 to move up and down, i.e. to move forwardly and backwardly along the axial axis 5_{b}. In those circumstances the diaphragm body 5 and, if present, the dust cap 2 actually produce the sound pressure. The spider 17 together with the support body 7 keeps the movable actuator part 11ₘ centered in the airgap 13 while moving. Furthermore the spider 17 may play an important role in tuning the resonance of the loudspeaker.

Although the present invention has been elucidated with reference to a preferred embodiment, it will be understood that the invention is not limited to the details described thereof. Various substitutions and modifications are intended to be embraced within the scope of the invention as defined in the claims.

1. An electrodynamic loudspeaker device comprising
a chassis (1),
a translatable body (3) provided with (1) a three-dimensional diaphragm body (5) having a contour (5_{c}), a diaphragm base part (5_{b}) and a diaphragm top part (5ₜ) which is wider than said base part (5_{b}), an axial axis (5ₐ) extending from the one part to the other part, and (2) a support body (7), which support body (7) has a bound support end portion (7_{b}) fixed to the diaphragm base part (5_{b}) and a free support end portion (7_{f}) and extends substantially parallel to said axial axis (5ₐ) and at least partly inside a space (9) enveloped by the contour (5_{c}) of the diaphragm body (5), and
an actuator (11) arranged for moving the translatable body (3) with regard to the chassis (1) along the axial axis (5ₐ),
wherein the actuator (11) comprises a stationary actuator part (11ₛ) supported by the chassis (1) and a movable actuator part (11ₘ) supported by the support body (7) and sited between both support end portions, said actuator parts being arranged for magnetically co-operating with each other across an air gap (13), and
wherein the diaphragm top part (5ₜ) is secured to the chassis (1) by means of a flexible suspension means (15) and the free support end portion (7_{f}) is suspended from the chassis (1) by means of a flexible centering means (17).

2. A loudspeaker device as claimed in claim 1, wherein the stationary actuator part (11ₛ) comprises a magnet unit (19) and the movable actuator part (11ₘ) comprises an electric coil unit.

3. A loudspeaker device as claimed in claim 1, wherein the diaphragm body (5) is a conical body.

4. A loudspeaker device as claimed in claim 1, wherein the support body (7) is a tube-like body.

5. A loudspeaker device as claimed in claim 1, wherein the flexible centering means (17) comprises a substantially flat spider web-like supporting structure having an inner edge (17ᵢ) attached to the free support end portion (7_{f}) and an outer edge (17ₒ) attached to the chassis (1).

6. A loudspeaker device as claimed in claim 2, wherein the magnet unit comprises an outside magnet unit part (19ₒ) extending outside of the support body (7) and in a space (21) bounded by the diaphragm body (5) and the flexible centering means (17).

7. A loudspeaker device as claimed in claim 6, wherein the outside magnet unit part (19ₒ) is a ring-shaped body which surrounds the support body (7) and is fixed to an axially extending frame (1_{f}) being a part of the chassis (1).

8. A loudspeaker device as claimed in claim 7, wherein the frame (1_{f}) has a truncate cone-shaped structure.

9. A loudspeaker device as claimed in claim 8, wherein the frame (1_{f}) is formed by a structure of pin-like elements extending substantially axially and through apertures in the flexible centering means (17).

10. A loudspeaker device as claimed in claim 6, wherein the outside magnet unit part (19ₒ) is or comprises a magnetizable unit.

11. A loudspeaker device as claimed in claim 6, wherein the magnet unit comprises an inside magnet unit part (19ᵢ) extending at least partly inside the support body (7).

12. A loudspeaker device as claimed in claim 11, wherein the inside magnet unit part (19ᵢ) is fixed to a central mounting structure (1ₘ) being a part of the chassis (1).

13. A loudspeaker device as claimed in claim 11, wherein the inside magnet unit part (19ᵢ) comprises at least one permanent magnet (19ₚ).
